(19) United States
(12) Patent Application Publication
(10) Pub. No.: US 2016/0288347 A1
(43) Pub. Date: Oct. 6, 2016

(54) HAIRCUT METHOD

(71) Applicant: Sayuri USHIO, Himeji-shi (JP)

(72) Inventor: Sayuri USHIO, Himeji-shi (JP)

(21) Appl. No.: 15/018,883

(22) Filed: Feb. 9, 2016

Related U.S. Application Data
(63) Continuation of application No. 13/983,812, filed on Aug. 6, 2013, now abandoned.

(51) Int. Cl. B26B 13/00

(52) U.S. Cl. CPC B26B 13/00

(57) ABSTRACT

A haircut method is provided that allows an amount of hair to be adjusted while the hair is cut, and prevents damage of the hair.

A haircut method of the present invention includes: dividing hair into a bang section that covers a front of a head, a side section that covers a side of the head, and a back section that covers a back of the head; dividing, in each of the sections, the hair into at least two blocks from an upper side of the head toward a lower side of the head; taking, as a bundle of hair, an amount of hair that can be cut in one operation in each of the blocks; and cutting the hair. In the step of cutting the hair, the hair except in the block located at an uppermost position in each of the sections is cut in such a manner that a bundle of hair is taken from the hair in each of the blocks, and the bundle of hair is cut slopewise such that the hair at an upper portion of the bundle of hair is shorter than the hair at a lower portion of the bundle of hair, and the bundle of hair is cut such that the hair at the upper portion of the bundle of hair is shorter than the hair at a lower portion of a block located immediately thereabove.

### TECHNICAL FIELD

The present invention relates to a haircut method.

### BACKGROUND ART

FIG. 6 shows a known haircut method. Basically, head hair is first divided into a bang section 101 that covers a front of a head, a side section 102 that covers a side of the head, and a back section 103 that covers a back of the head. In each of the sections, the hair is further divided into multiple blocks in a vertical direction, namely, 101aa, 101ab; 102aa, 102ab, 102b; and 103aa, 103ab, 103b and 103c. Thereafter, an amount of hair that can be cut in one operation is taken as a bundle of hair (panel) 3 in each block, and a tip portion of the panel 3 is cut with scissors. At this time, as shown in FIG. 6, the hair is cut such that lines (cut-lines) 104 formed by cutting the hair with scissors become individually continuous with the lines of adjacent blocks (such that the lengths from the roots to each of the circles in FIG. 6 are almost the same). Thereafter, the amount of hair is adjusted, for example, in the manner described below. Specifically, the tips of the hair are thinned at predetermined positions away from the tips of the hair with thinning scissors; or the tips of the hair are thinned by cutting the hair with scissors along a hair stream. Thus, as indicated by polygonal lines 105 in FIG. 6, the hair is shortened in some portions by thinning at the tips, reducing the amount of hair (Non-patent Literature 1, Non-patent Literature 2).

### CITATION LIST

### Non-Patent Literature

NPL 1: “TOMOTOMO (January 2008),” published by Shinbiyo Shuppan Kabushiki Kaisha, Jan. 1, 2008, p. 83

NPL 2: “Gekkan BOB,” published by Kabushiki Kaisha Kamishobo, Oct. 1, 2010, p. 66

### SUMMARY OF INVENTION

### Technical Problem

However, in the haircut method shown in FIG. 6, when the amount of hair is adjusted, the scissors inadvertently touch the hair that is not to be cut for thinning, thus rubbing against the hair and causing damage thereto. Further, although the hair is thinned every time one gets a haircut, the hair is not always thinned at the desired portions, and the tips of some portions of the hair may remain unintentionally uncut. This causes a problem such that the tips of such portions of the hair tend to easily become damaged. Further, in the haircut method described above, the amount of hair is adjusted normally in only tip portions of the hair. Even when an attempt is made to thin the hair in an excess amount, only the hair from mid-portions towards the tips, in addition to the tip portions, is thinned. Thus, no reduction in hair volume is observed in the portion between the roots of the hair and mid-portions; therefore, the hair is likely to remain thick in such a portion.

The present invention is made to solve the aforementioned problems. The present invention provides a haircut method that allows the amount of hair to be adjusted while the hair is cut, and that prevents damage to the hair.

### Solution to Problem

The haircut method of the present invention includes the steps of dividing hair into a bang section, a side section, and a back section; dividing the hair in each of the sections into at least two blocks; and cutting the hair.

The hair in the bang section covers a front of a head, the hair in the side section covers a side of the head, and the hair in the back section covers a back of the head. In each of the above sections, the hair is further divided into at least two blocks. In each of the blocks, a bundle of hair in an amount that can be cut in one cutting operation is taken out and the bundle of hair is then cut.

In the step of cutting the hair, the hair in each of the blocks other than that located at the uppermost position in each of the sections is cut in the following manner. That is, a bundle of hair is taken out, and cut it slopewise such that the hair at an upper portion of the bundle is shorter than the hair at a lower portion of the bundle. At the same time, the bundle of hair is cut so that the hair at the upper portion of the bundle is shorter than the hair at a lower portion of a block that is located immediately thereabove.

In the description, the terms “slope,” “slopewise,” and “sloped” indicate an incline relative to a line perpendicular to the hair when a panel is taken out. The “uppermost block” is a block that covers a surface of the hair, and that determines an outline of a hairstyle. These terms are used in the same manner throughout the description.

In the above-described haircut method, when dividing the hair into blocks, the hair in the side section and the back section may be divided into at least two blocks along a horizontal line below Hachi, i.e., projections in the lateral region of the head, and along a horizontal line above Bonnokubo, i.e., the hollow of the nape, which is the most greatly recessed portion in the back of the head.

In the above-described haircut method, during the division of the hair into the blocks, the hair in the block that is included in the back section and located between the two horizontal lines, one is located below the projections in the lateral region of the head and another is located above the hollow of the nape, may be further divided into a left block, a center block, and a right block. In the following blocks, the bundle of hair may be cut along a concave curve such that the hair becomes shorter from an upper portion toward a mid-portion in the bundle of hair and the hair then becomes longer toward a lower portion of the bundle of hair. The blocks, in which the hair is cut in this manner, include the block that is included in the side section and located below the horizontal line below the projections in the lateral region of the head; the left block in the back section; the right block in the back section; and the block that is included in the back section and located below the horizontal line above the hollow of the nape.

### Advantageous Effects of Invention

According to the haircut method of the present invention, the amount of hair can be adjusted while the hair is cut. This eliminates the necessity of thinning the hair, and prevents damage to the hair.

### BRIEF DESCRIPTION OF DRAWINGS

FIG. 1 is a side view illustrating a haircut method according to one embodiment of the present invention.

FIG. 2 is a perspective view illustrating a panel taken out in the form of a vertical slice.

FIG. 3 is a side view illustrating a haircut method according to another embodiment of the present invention.

FIG. 4 is a rear view illustrating division into blocks in a haircut method according to an example of the present invention.

FIG. 5 is a side view illustrating a haircut method according to an example using the division into the blocks as shown in FIG. 4.

FIG. 6 is a side view illustrating a known haircut method.

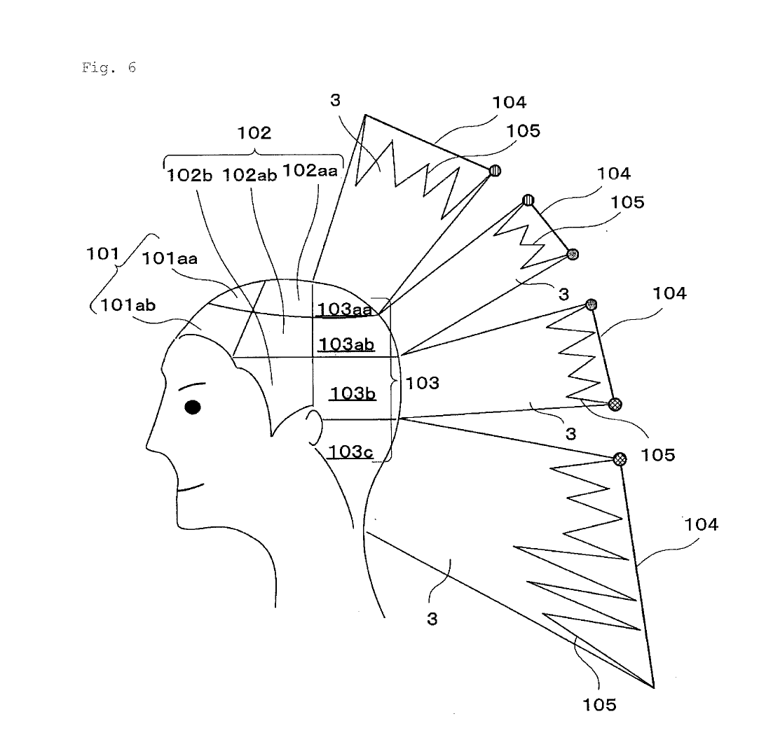

### DESCRIPTION OF EMBODIMENTS

Hereinafter, one embodiment of the haircut method of the present invention will be described with reference to the accompanying drawings.

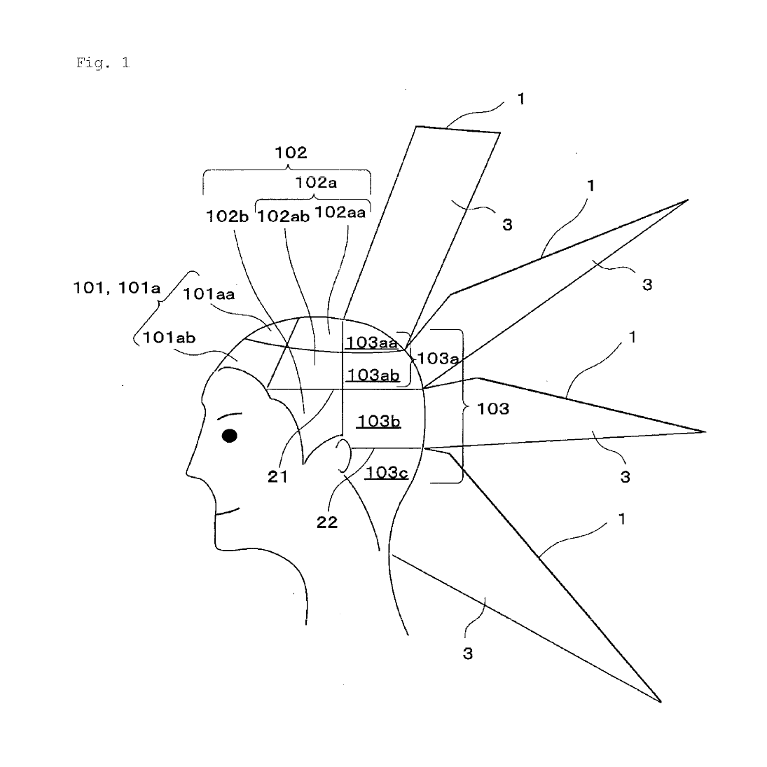

First, hair is divided into a bang section 101 that covers a front of a head, a side section 102 that covers a side of the head, and a back section 103 that covers a back of the head, as shown in FIG. 1. In each of the sections 101 to 103, the hair is divided into blocks along a first horizontal line 21 below the projections in the lateral region of the head, and a second horizontal line 22 above the hollow of the nape, which is the most greatly recessed portion in the back of the head. Specifically, the hair in each section is divided into blocks 101a, 102a, and 103a located above the first horizontal line 21; blocks 102b and 103b located between the first horizontal line 21 and the second horizontal line 22; and a block 103c located below the second horizontal line 22. In the sections 101 to 103, each of the blocks 101a, 102a, and 103a located above the first horizontal line 21 may be further respectively divided into two blocks (i.e., upper and lower blocks) 101aa and 101ab; 102aa and 102ab; and 103aa and 103ab. More specifically, as shown in FIG. 1, the bang section 101 may be divided into two blocks, i.e., 101aa and 101ab; the side section 102 may be divided into three blocks, i.e., 102aa, 102ab, and 102b; and the back section 103 may be divided into four blocks, i.e., 103aa, 103ab, 103b, and 103c. Thereafter, the hair is cut sequentially from the lower block toward the upper block for each of the sections 101 to 103 as seen from the top of the head. The use of the first and the second horizontal lines 21 and 22 to divide the hair into blocks, i.e., 101a; 102a and 102b; and 103a, 103b, and 103c, allows the most greatly projecting portions and the most greatly recessed portion of the head to serve as boundaries for each block, making it easier to provide various hairstyles.

Hereinafter, the back section 103 will be described as an example. In this specification, the block located at the lowermost position in the back section 103, i.e., the block located below the second horizontal line 22 in the back section 103, is referred to as nape 103c. Further, the block located between the second horizontal line 22 and the first horizontal line 21 is referred to as middle 103b. Moreover, the block located above the first horizontal line 21 is referred to as top 103a; and the block located at the lower portion of the top 103a is referred to as lower-top 103ab, and the block located at the upper portion of the top 103a is referred to as upper-top 103aa.

In the bang section 101 and the side section 102, the hair can also be cut in the manner described below. Specifically, in the present embodiment, the bang section 101 is divided into two blocks, i.e., the blocks 101aa and 101ab; and the side section 102 is divided into three blocks, i.e., the blocks 102aa, 102ab, and 102b. Here, the hair in the blocks 101aa and 102aa, which are the uppermost blocks in the sections 101 and 102, respectively, is cut in the same manner as the hair in the upper-top 103aa, which is the uppermost block in the back section 103. Further, the hair in the blocks 101ab and 102b, which are the lowermost blocks in the sections 101 and 102, respectively, is cut in the same manner as the hair in the nape 103c, which is the lowermost block in the back section 103. Further, the hair in the block 101ab, which is the middle block in the side section 102, is cut in the same manner as the hair in the lower-top 103ab or the middle 103b in the back section 103.

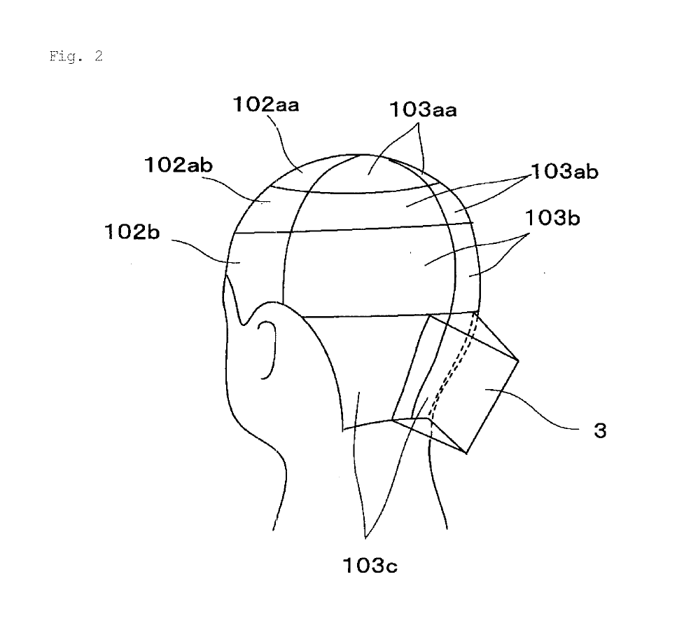

Firstly, a method for cutting the hair in the nape 103c, which is the lowermost block in the back section, will be described. As shown in FIG. 2, a bundle of hair (panel) 3 in an amount that can be cut in one cutting operation is taken out from the nape 103c. The panel 3 is a bundle of hair that has been taken by a vertical slicing technique that forms a parting line on the head in the vertical direction. In other words, the hair has been taken out so that the bundle of hair forms a longitudinally long shape. The hair of the panel 3 is cut along the cut-line 1 shown in FIG. 1. The cut-line 1 is sloped (a right-downward slope in FIG. 1) such that the hair at the upper portion of the panel 3 is shorter than that at the lower portion of the panel 3, and the hair at the upper portion of the panel 3 is shorter than that at the lower portion of the middle 103b, which is located immediately above the nape 103c. More specifically, the hair is cut slopewise by slide-cutting toward the tips of the hair in the lower portion of the panel 3, from the vicinity of the roots, preferably about 5 cm from the roots of the hair in the upper portion of the panel 3. A series of operations of taking out the panel 3 and cutting it slopewise is repeated in the horizontal direction to cover the entire nape 103c, allowing all of the hair in the nape 103c to be cut in the same manner.

After the hair in the nape 103c is cut, the hair in the middle 103b (the block immediately above the nape 103c) is then cut. Here, a panel 3 is also taken out from the middle 103b in the same manner as the nape 103c, and the hair is cut along the sloped cut-line such that the hair at the upper portion of the panel 3 is shorter than that at the lower portion of the panel 3. Here, the hair is cut in such a manner that the hair at the upper portion of the panel 3 has a length equal to or longer than that of the hair at the upper portion of the nape 103c, which is located immediately below the middle 103b; and, at the same time, the length of the hair at the upper portion of the panel is shorter than that at the lower portion of the lower-top 103ab, which is located immediately above the middle 103b. The hair of the panel 3 is cut slopewise from the upper portion toward the tips of the hair at the lower portion by slide-cutting. In this block as well, a series of operations of taking out the panel 3 and cutting it slopewise is repeated in the horizontal direction to cover the entire region of the middle 103b in the same manner as the nape 103c, allowing all of the hair in the middle 103b to be cut in the same manner.

Subsequently, the hair in the lower-top 103ab (the block immediately above the middle 103b) is cut. In the lower-top 103ab as well, a panel 3 is taken out in the same manner as the nape 103c, and the hair is cut along the sloped cut-line 1 such that the hair at the upper portion of the panel 3 is shorter than that at the lower portion of the panel 3. Here, the hair is cut in such a manner that the length thereof at the upper portion of the panel 3 is equal to or longer than that of the hair at the upper portion of the middle 103b, which is located immediately below the lower-top 103ab; and, at the same time, the length of the hair at the upper portion of the hair is shorter than that at the lower portion of the upper-top 103aa, which is located immediately above the lower-top 103ab. The hair of the panel 3 is cut slopewise from the upper portion toward the tips of the hair at the lower portion by slide-cutting. In this block as well, a series of operations of taking out the panel 3 and cutting it slopewise is repeated in the horizontal direction to cover the entire region of the lower-top 103ab in the same manner as the nape 103c, allowing all of the hair in the lower-top 103ab to be cut in the same manner.

As a last step, the hair in the upper-top 103aa (the uppermost block) is cut. In the upper-top 103aa as well, a panel 3 is taken out in the same manner as the nape 103c, and the hair is then cut by panel by panel. Because the hair of the upper-top 103aa covers that of the lower-top 103ab, the middle 103b, and the nape 103c, the hair of the upper-top 103aa determines the outline of the overall hairstyle. Therefore, the hair of the upper-top 103aa is cut along the cut-line 1 according to the client's request. For example, when a client requests a one-length cut, the hair is cut along the cut-line 1 in a manner that allows the tips of the hair to be aligned in a straight line when the hair is let down. When a client requests a layered cut, the hair is cut along the cut-line 1 in a manner that allows the tips of the hair to be layered when the hair is let down. The hair of the upper-top 103aa is cut in such a manner that meets the client's request and that covers the short hair in the upper portions of the lower-top 103ab, the middle 103b, and the nape 103c. Therefore, even when the hair in the upper portions of the lower-top 103ab, the middle 103b, and the nape 103c is cut short, such short hair becomes less conspicuous.

As described above, according to the present embodiment, the hair around boundaries (namely, a boundary between the nape 103c and the middle 103b, a boundary between the middle 103b and the lower-top 103ab, and a boundary between the lower-top 103ab and the upper-top 103aa) is cut so that an upper portion of a block located immediately below has shorter hair relative to a lower portion of a block located immediately above. This makes it unnecessary to align the length of the hair in the lower portion of a block with that of the hair in the upper portion of the block located immediately therebelow, enabling haircuts to be performed readily and quickly. This also results in the presence of short hair sandwiched between the nape 103c and the middle 103b, between the middle 103b and the lower-top 103ab, and between the lower-top 103ab and the upper-top 103aa, allowing the amount of hair to be reduced. Because the hair is cut while the amount of hair is reduced, thinning after cutting becomes unnecessary. This eliminates the risk of damaging the hair. Furthermore, because the same portion of hair is not cut twice, the cutting efficiency can be enhanced. Further, the presence of short hair around the boundaries forms interspaces between the nape 103c and the middle 103b, between the middle 103b and the lower-top 103ab, and between the lower-top 103ab and the upper-top 103aa. Due to the presence of the interspaces, the hair is less likely to thicken, and the cut-line is less likely to lose its shape, even when the hair grows longer. In addition, the short hair between the nape 103c and the middle 103b, between the middle 103b and the lower-top 103ab, and between the lower-top 103ab and the upper-top 103aa, is less likely to stick out, since the tips of the short hair do not appear on the surface of the hair. Therefore, it is only necessary to care for the tips of the hair that appear on the surface of the hair, making it easy to maintain the hairstyle.

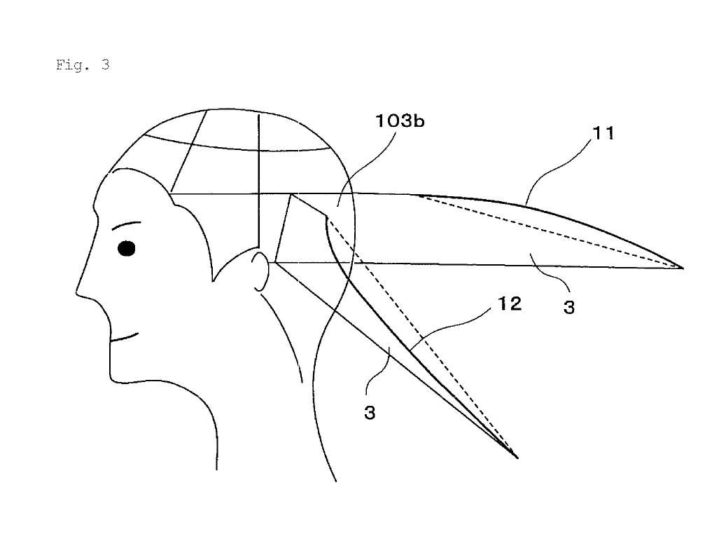

Further, in the case of a flat-back head, i.e., a so-called bluff-shaped head, volume can be easily added by cutting the hair so as layer it in a portion in which expansion is desired. Specifically, in the center of the back of the head (i.e., the center of the middle 103b), in which increased hair volume is desired, the hair is cut so as to have an arcuate shape (convex) that is expanded upward, as indicated by the cut-line 11 in FIG. 3. On the other hand, to reduce hair volume on the lateral sides (the right and the left portions of the middle 103b), the hair is cut so as to have an arcuate (concave) shape that is recessed downward, as indicated by the cut-line 12 in FIG. 3. This adds volume to the hair in the center of the back of the head, thereby improving the undesirable flat appearance of the back of the head.

Further, in the case of a head with an angular forehead (so-called hachihari, i.e., a head with undesirable projections), the hair is cut in a concave shape such that the hair is prevented from being layered in the projecting portion (e.g., the block 101ab that is the lower portion of the bang section). Thus, the undesirably projecting portion can be made less conspicuous.

As described above, by alternating the inclination angle of the cut-line 1 and the length of the hair in each block of each section, the length and volume of the hair can be adjusted. This makes it possible to perform haircuts with various designs. In addition, since a position at which the volume of the hair is to be increased or reduced can be suitably selected, the appearance of the head can be made to have a more desirable three-dimensional look. This allows the head to look smaller or the neck to look longer, and the entire body to look more well-balanced. Further, this method makes it possible to easily understand the positions at which the hair is divided into the blocks, i.e., below the projections in the lateral region of the head and above the hollow in the nape of the neck; sloped cut-lines in each block; etc. Furthermore, the amount of hair need not be adjusted based on feeling with reference to the hairstyle after the hair is cut. Therefore, the haircut method of the present invention is advantageous both for instructors who teach the haircut method, and for trainees who would like to learn the haircut method; i.e., it is easy to teach and easy to learn.

One embodiment of the present invention has been described above; however, the present invention is not limited to the embodiment, and various modifications can be made without departing from the gist of the invention. For example, in the above embodiment, the sections 101 to 103 are divided as follows. Specifically, the bang section 101 is divided into two blocks (i.e., blocks 101aa and 101ab); the side section 102 is divided into three blocks (i.e., blocks 102aa, 102ab, and 102b); and the back section 103 is divided into four blocks (i.e., blocks 103aa, 103ab, 103b, and 103c). However, the number of blocks obtained by the division is not limited to that described above, and can be suitably selected depending on the client's head shape or the requested hairstyle. For example, for a very short hairstyle, the block in each section located above the first horizontal line 21 may be divided into three sub-blocks; and the block in each section located between the first horizontal line 21 and the second horizontal line 22, and the block in each section located below the second horizontal line 22 may be each divided into two sub-blocks. Such a division of the blocks prevents the shorter hair sandwiched between the blocks from appearing on the surface, even when the hair is cut very short, because the intervals between the blocks are very small. For a narrow forehead or a head having a shape so-called Hachihari, i.e., having undesirable projections, the block located above the first horizontal line 21 is divided into three sub-blocks. Thus, even when the forehead is narrow and the bangs are short, the shorter hair sandwiched between the blocks can be prevented from appearing on the surface in the same manner as described above. Furthermore, because the cutting method can be suitably altered for each of the small divided blocks, the undesirable projections can easily be made less conspicuous. Even when the number of the blocks in each section is thus changed, the hair in the uppermost block in each section is cut in the same manner as that for the upper-top 103aa explained in the embodiment. Similarly, the hair in the lowermost block in each section is cut in the same manner as that for the nape 103c explained in the embodiment. Further, in each section, the hair in the blocks located between the uppermost block and the lowermost block is cut in the same manner as that for the lower-top 103ab or the middle 103b explained in the embodiment.

In the present invention, in each block, the hair is cut slopewise from the upper side toward the lower side. The slope may be formed as a straight cut-line 1, as shown in FIG. 1; or formed as a convex cut-line 11 or a concave cut-line 12, as shown in FIG. 3. For example, when adding volume to the hair is desired, the hair will be cut in a convex shape to reduce the amount of hair to be cut. On the other hand, when making the hair look light and tight is desired, the hair will be cut in a concave shape to increase the amount of hair to be cut. Further, the hair may be cut, with a cut-line combining a concave shape and a convex shape, from the upper side toward the lower side of a panel 3.

FIG. 1 and FIG. 3 illustrate a haircut for a shoulder length hairstyle. However, the same cutting method can be employed for a long hairstyle, a short hairstyle, and other hairstyles.

### EXAMPLES

Hereinafter, an example of a haircut method that uses the haircut method according to the above embodiment is explained. In particular, a haircut method that allows correction of a flat-back appearance and that makes a head look streamlined is described below.

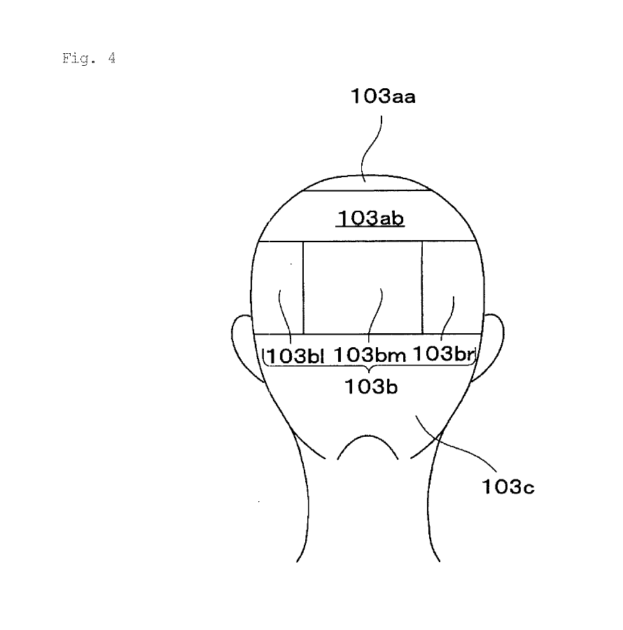

The bang section 101 and the side section 102 are respectively divided into two blocks and three blocks as described in the embodiment (see FIG. 1). As shown in FIG. 4, the hair in the back section 103 is divided into three blocks, namely, a top 103a, a middle 103b, and a nape 103c, along the first horizontal line 21 and the second horizontal line 22 from the upper side toward the lower side of the head. The top 103a is further divided into two blocks (i.e., upper and lower blocks), namely, an upper-top 103aa and a lower-top 103ab. The middle 103b is further divided into three blocks, i.e., blocks 103bl, 103bm, and 103br, in the horizontal direction. Specifically, the middle 103b is divided into four nearly equal portions in the horizontal direction; and two middle portions are integrated into one block (hereinafter referred to as “center-middle 103bm”). The block to the left of the center-middle 103bm is referred to as left-middle 103bl, and the block to the right of the center-middle 103bm is referred to as right-middle 103br.

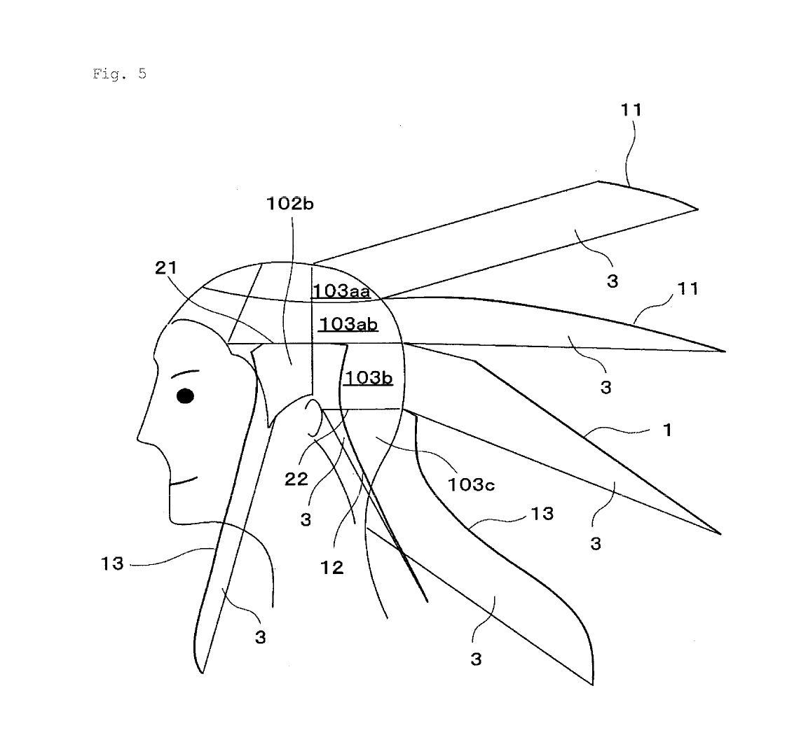

The hair thus divided into blocks is then cut along the cut-lines shown in FIG. 5. As described in the embodiment, the procedure of cutting the hair can be completed by repeating a series of operations, i.e., taking out a panel 3 from the hair in the target block by vertical slicing and then cutting the hair along the cut-lines described below, in the entire region of the block.

Firstly, in the nape 103c and in the block 102b that is located below the first horizontal line 21 in the side section 102, the hair is cut from the upper portion toward the lower portion of the panel 3 along a cut-line 13. The cut-line 13 has a concave shape in the upper-half portion and a convex shape in the lower-half portion. Specifically, the hair is cut along a slope making a concave curve in which the hair becomes very short from the upper portion toward the vicinity of the mid-portion; conversely, the hair is cut so that it remains long near the mid-portion, and forms a slope making a gentle convex curve from the vicinity of the mid-portion toward the lower portion of the panel 3.

Next, in the left-middle 103bl and in the right-middle 103br, the hair is cut along a concave cut-line 12. The concave cut-line 12 is formed of a slope making a concave curve in which the hair becomes very short from the upper portion toward the vicinity of the mid-portion of the panel 3, and the hair remains long from the vicinity of the mid-portion toward the lower portion.

As described above, in the nape 103c, the block 102b that is located below the first horizontal line 21 in the side section 102, the left-middle 103bl, and the right-middle 103br, the hair is cut such that the hair in the upper portion of each of the blocks 103c, 102b, 103bl, and 103br becomes very short. This allows the head to look tight on the sides of the head, behind the ears, and below the hollow of the nape. On the other hand, in the nape 103c and in the block 102b that is located below the first horizontal line 21 in the side section 102, the hair is cut along a convex cut-line in the lower portion of each of the blocks 103c and 102b, allowing volume to be added to the tips of the hair.

Next, in the center-middle 103bm, the hair is cut along the cut-line 1 formed as a straight (even) line or a convex line (FIG. 5 shows an even cut-line). Here, the hair is cut in such a manner that the hair at the upper portion of the center-middle 103bm is longer than that at the upper portion of each of the left-middle 103bl and the right-middle 103br. Thus, a large amount of hair remains in the center of the back of the head, adding volume to the center of the back of the head. Further, to add more volume to the center of the back of the head, the hair in the center-middle 103bm is preferably cut along a convex cut-line.

As a last step, in the upper-top 103aa that forms the outline of the hairstyle, the hair is cut only in tip portions along a gently sloped, convex cut-line 11. This makes the tips of the hair curl inward in the portion that forms the outline of the hairstyle, making the hair easily manageable. In other blocks, an even, convex, or concave cut-line may be appropriately combined depending on a design desired by a client.

The haircut method described above can put volume in the center (the center-middle 103bm) of a flat-back head; i.e., a so-called bluff-shaped head. At the same time, the portions surrounding the center of the back of the head, i.e., sides of the head, behind the ears, and a portion below the hollow of the nape, can be made to look tight. This makes the volumized hair in the center of the back of the head to more conspicuous, and provides a flat-lined head with a more desirable three-dimensional appearance.

While one example of the present invention has been described above, the present invention is not limited to only this example. As described above in the example, various hairstyles become available by desirably combining convex, concave, or even cut-lines.

### DESCRIPTION OF THE REFERENCE CHARACTERS

3 panel (bundle of hair)
21 horizontal line below projections in the lateral region of the head (first horizontal line)
22 horizontal line above hollow of the nape (second horizontal line)
101 bang section
101aa, 101ab blocks
102 side section
102a, 102b blocks
102aa, 102ab blocks
103 back section
103a, 103b, 103c blocks
103aa, 103ab blocks
103bl left block
103bm center block
103br right block

1. A haircut method comprising:
dividing hair into a bang section that covers a front of a head, a side section that covers a side of the head, and a back section that covers a back of the head;
dividing, in each of the sections, the hair into at least two blocks from an upper side of the head toward a lower side of the head;
taking, as a bundle of hair, an amount of hair that can be cut in one operation in each of the blocks; and
cutting the hair,
wherein
in the step of cutting the hair, the hair except in the block located at an uppermost position in each of the sections is cut in such a manner that a bundle of hair is taken from the hair in each of the blocks, and the bundle of hair is cut slopewise such that the hair at an upper portion of the bundle of hair is shorter than the hair at a lower portion of the bundle of hair, and the bundle of hair is cut such that the hair at the upper portion of the bundle of hair is shorter than the hair at a lower portion of a block located immediately thereabove.

2. The haircut method according to claim 1, wherein, in the step of dividing the hair into the blocks, the hair of each of the side section and the back section is divided into at least two blocks along a horizontal line below projections in the lateral region of the head, and a horizontal line above a hollow of the nape that is the most greatly recessed portion in the back of the head.

3. The haircut method according to claim 2, wherein in the step of dividing the hair into the blocks, the hair in the block that is included in the back section and located between the horizontal line below the projections in the lateral region of the head and the horizontal line above the hollow of the nape is further divided into a left block, a center block, and a right block, and
in the step of cutting the hair, in the block that is included in the side section and located below the horizontal line below the projections in the lateral region of the head, the left block, the right block, and the block that is included in the back section and located below the horizontal line above the hollow of the nape, the bundle of hair is cut along a concave curve such that the hair becomes shorter from an upper portion toward a mid-portion in the bundle of hair and the hair then becomes longer toward a lower portion of the bundle of hair.
